(19) United States
(12) Patent Application Publication
(10) Pub. No.: US 2024/0094354 A1
(43) Pub. Date: Mar. 21, 2024

(54) CARRIER EXTRACTION FROM SEMICONDUCTING WAVEGUIDES IN HIGH-POWER LIDAR APPLICATIONS

(71) Applicant: Waymo LLC, Mountain View, CA (US)

(72) Inventor: Alexander Yukio Piggott, Mountain View, CA (US)

(21) Appl. No.: 17/947,976

(22) Filed: Sep. 19, 2022

(51) Int. Cl. G01S 7/481; G02B 6/35

(52) U.S. Cl. CPC G01S 7/4818; G02B 6/3596

(57) ABSTRACT

The subject matter of this specification can be implemented in, among other things, systems and methods of optical sensing that use carrier extraction from waveguides that can support propagation of high-power sensing beams. Described, among other things, is a system that includes one or more waveguides that include a semiconducting material with a temperature-dependent refractive index. The system further includes a plurality of extraction electrodes configured to extract from the waveguide(s), charge carriers generated by an electromagnetic wave propagating in the waveguide(s). The system further includes a heating electrode configured to cause a change of a temperature of the waveguide(s).

### TECHNICAL FIELD

The instant specification generally relates to range and velocity sensing in applications that involve determining locations and velocities of moving objects using optical signals reflected from the objects. More specifically, the instant specification relates to systems and techniques that reduce power losses in high-power lidar devices.

### BACKGROUND

Various automotive, aeronautical, marine, atmospheric, industrial, and other applications that involve tracking locations and motion of objects benefit from optical and radar detection technology. A rangefinder (radar or optical) device operates by emitting a series of signals that travel to an object and then detecting signals reflected back from the object. By determining a time delay between a signal emission and an arrival of the reflected signal, the rangefinder can determine a distance to the object. Additionally, the rangefinder can determine the velocity (the speed and the direction) of the object's motion by emitting two or more signals in a quick succession and detecting a changing position of the object with each additional signal. Coherent rangefinders, which utilize the Doppler effect, can determine a longitudinal (radial) component of the object's velocity by detecting a change in the frequency of the arrived wave from the frequency of the emitted signal. When the object is moving away from (or towards) the rangefinder, the frequency of the arrived signal is lower (higher) than the frequency of the emitted signal, and the change in the frequency is proportional to the radial component of the object's velocity. Autonomous (self-driving) vehicles operate by sensing an outside environment with various electromagnetic (radio, optical, infrared) sensors and charting a driving path through the environment based on the sensed data. Additionally, the driving path can be determined based on Global Navigation Satellite System (GNSS) data and road map data. While the GNSS and the road map data can provide information about static aspects of the environment (such as buildings, street layouts, etc.), dynamic information (such as information about other vehicles, pedestrians, cyclists, etc.) is obtained from contemporaneous electromagnetic sensing data. Precision and safety of the driving path and of the speed regime selected by the autonomous vehicle depend on the quality of the sensing data and on the ability of autonomous driving computing systems to process the sensing data and to provide appropriate instructions to the vehicle controls and the drivetrain.

### BRIEF DESCRIPTION OF THE DRAWINGS

The present disclosure is illustrated by way of examples, and not by way of limitation, and can be more fully understood with references to the following detailed description when considered in connection with the figures, in which:

FIG. 1 is a diagram illustrating components of an example autonomous vehicle that deploys a lidar device capable of supporting high-power sensing beams by implementing carrier extraction of photogenerated carriers from light guiding media and various optical elements, in accordance with some implementations of the present disclosure.

FIG. 2A is a block diagram illustrating an example implementation of an optical sensing system that deploys photogenerated carrier extraction, in accordance with some implementations of the present disclosure.

FIG. 2B is a block diagram illustrating another example implementation of an optical sensing system that deploys photogenerated carrier extraction, in accordance with some implementations of the present disclosure.

FIGS. 3A-B illustrate example architecture and operations of an element of a photonic integrated circuit configured for extraction of charge carriers generated by a lidar transmitter beam of an optical sensing system, in accordance with some implementations of the present disclosure.

FIG. 4A illustrates an example section of a waveguide with both heating and extraction of photogenerated charge carriers to support controlled propagation of high-power electromagnetic waves, in accordance with some implementations of the present disclosure.

FIG. 4B illustrates an example section of multiple waveguides sharing a common set of extraction electrodes and equipped with separate heating electrodes, in accordance with some implementations of the present disclosure.

FIG. 4C illustrates an example section of multiple waveguides with a common heating electrode and extraction electrodes shared across multiple waveguides, in accordance with some implementations of the present disclosure.

FIG. 4D illustrates another example section of multiple waveguides with a common heating electrode and extraction electrodes shared across multiple waveguides, in accordance with some implementations of the present disclosure.

FIG. 5 is a top view of a waveguide structure with a multi-path configuration equipped with a heating electrode and extraction electrodes, for controlled guiding of high-power electromagnetic waves in photonic integrated circuits, in accordance with some implementations of the present disclosure.

FIG. 6 depicts a flow diagram of an example method of operating an optical sensing system (e.g., a lidar) that uses high-power sensing beams enabled by extraction of photogenerated carriers, in accordance with some implementations of the present disclosure.

### SUMMARY

In one implementation, disclosed is an optical device that includes a first waveguide having a semiconducting material with a temperature-dependent refractive index, and a plurality of extraction electrodes configured to extract, responsive to a voltage configuration, from the first waveguide, charge carriers generated by a first electromagnetic wave propagating in the first waveguide. The optical device further includes a first heating electrode configured to cause a change of a temperature of the first waveguide.

In another implementation, disclosed is a lidar system that includes a light source configured to generate a transmitted (TX) beam and a photonic integrated circuit (PIC). The PIC includes a waveguide configured to guide the TX beam, wherein the waveguide includes semiconducting material. The PIC further includes a plurality of extraction electrodes configured to extract, responsive to a voltage configuration, from the semiconducting material of the waveguide, charge carriers generated by the TX beam.

In another implementation, disclosed is a method to operate a lidar device. The method includes directing a first beam to a first waveguide comprising a semiconducting material with a temperature-dependent refractive index. The method further includes using a plurality of extraction electrodes to extract, from the first waveguide, charge carriers generated by the first beam in the first waveguide. The method further includes using a heating electrode to impart a phase change to the first beam to obtain a modified first beam. The method further includes generating, using the modified first beam, a transmitted beam, and using the transmitted beam to detect at least one of (i) a distance to an object in an outside environment or (ii) a speed of the object.

### DETAILED DESCRIPTION

An autonomous vehicle (AV) or a driver-operated vehicle that uses various driver-assistance technologies can employ light detection and ranging (lidar) systems to detect distances to various objects in the environment and, sometimes, the velocities of such objects. A lidar emits one or more laser signals (pulses) that travel to an object and then detects incoming signals reflected from the object. By determining a time delay between the signal emission and the arrival of the reflected waves, a time-of-flight (ToF) lidar can determine the distance to the object. A typical lidar emits signals in multiple directions to obtain a wide view of the driving environment of the AV. The outside environment can be any environment including any urban environment (e.g., a street, and a sidewalk), rural environment, highway environment, indoor environment (e.g., the environment of an industrial plant, a shipping warehouse, and a hazardous area of a building), marine environment, and so on. The outside environment can include multiple stationary objects (e.g., roadways, buildings, bridges, road signs, shoreline, rocks, trees), multiple movable objects (e.g., vehicles, bicyclists, pedestrians, animals, ships, and boats), and/or any other objects located outside the AV. For example, a lidar device can cover (e.g., scan) an entire 360-degree view by collecting a series of consecutive frames identified with timestamps. As a result, each sector in space is sensed in time increments that are determined by the angular velocity of the lidar's scanning speed. Sometimes, an entire 360-degree view of the outside environment can be obtained over a scan of the lidar. Alternatively, any smaller sector, e.g., a 1-degree sector, a 5-degree sector, a 10-degree sector, or any other sector can be scanned, as desired.

ToF lidars can also be used to determine velocities of objects in the outside environment, e.g., by detecting two (or more) locations \vec{r}(t₁), \vec{r}(t₂) of some reference point of an object (e.g., the front end of a vehicle) and inferring the velocity as the ratio, \vec{v}=[\vec{r}(t₂)−\vec{r}(t₁)]/[t₂−t₁]. By design, the measured velocity \vec{v} is not the instantaneous velocity of the object but rather the velocity averaged over the time interval t₂−t₁, as the ToF technology does not allow to ascertain whether the object maintained the same velocity \vec{v} during this time or experienced an acceleration or deceleration (with detection of acceleration/deceleration requiring additional locations \vec{r}(t₃), \vec{r}(t₄) . . . of the object).

Coherent or Doppler lidars operate by detecting, in addition to ToF, a change in the frequency of the reflected signal—the Doppler shift—indicative of the velocity of the reflecting surface. Measurements of the Doppler shift can be used to determine, based on a single sensing frame, radial components (along the line of beam propagation) of the velocities of various reflecting points belonging to one or more objects in the outside environment. A signal emitted by a coherent lidar can be modulated (in frequency and/or phase) with a radio frequency (RF) signal prior to being transmitted to a target. A local oscillator (LO) copy of the transmitted signal can be maintained on the lidar and mixed with a signal reflected from the target; a beating pattern between the two signals can be extracted and Fourier-analyzed to determine the Doppler frequency shift of f_{D} and signal travel time τ to and from the target. The (radial) velocity V of the target relative to the lidar and the distance L to the target can then be determined as

$$V = \frac{c {f}_{D}}{2 f} , \qquad L = \frac{c τ}{2} .$$

where c is the speed of light and f is the optical frequency of the transmitted signal. More specifically, coherent lidars can determine the velocity of the target and the distance to the target by correlating phase information ϕ_{R}(t) of the reflected signal with phase modulation ϕ_{LO}(t−τ) of the time-delayed local oscillator (LO) copy of the transmitted signal. The correlations can be analyzed in the Fourier domain with a peak of the correlation function identifying the time of flight τ.

Sensing beams transmitted by lidar devices undergo significant attenuation on the way to a target and back, as a result of beam spreading and scattering on atmospheric particles. Furthermore, surfaces of target objects typically cause at least partially diffuse scattering of lidar beams, with a substantial portion of the light scattered away from the lidar device. As a result, the intensity of the reflected light that reaches back to the lidar device can be orders of magnitude smaller than the intensity of the transmitted beam. To improve efficiency and accuracy of lidar sensing, it is therefore advantageous to increase the intensity (power) of the transmitted beam, so that the intensity of the returned light can be increased proportionally. Nonlinear optical effects, however, often hinder increasing the intensity of the transmitted beam. For example, many modern optical devices (including lidars) use photonic integrated circuits (PICs) that combine waveguides, beam splitters, optical (e.g., directional) couplers, light switches, phase shifters, optical amplifiers, diffraction gratings, photodiodes, and other optical elements on a single substrate (chip). Various integrated optical elements of PIC can be implemented using semiconductor materials (e.g., silicon) that allow a great amount of control over the optical properties via chemical and electrostatic doping, electro-optic effect (sensitivity of the refractive index to electric field), thermo-optic effect (sensitivity of the refractive index to temperature), and the like.

The high degree of control over the properties of silicon is predicated on the relatively small bandgap of silicon (1.12 eV). The same small bandgap, however, leads to pronounced optical losses when high-power light beams propagate through silicon-based devices. For example, a diode-pumped YAG laser can emit photons with the wavelength of 1064 nm (1.17 eV) and, therefore, has sufficiently large energy to excite an electron-hole pair in silicon. Other lasers may emit photons with energy that is smaller than the bandgap of silicon, e.g., 1310 nm (0.95 eV) or 1550 nm (0.80 eV), in which instances electron-hole pairs may be excited via the two-photon absorption. Once a significant density of electrons and holes is established in, respectively, the conduction band and the valence band, an additional absorption channel opens up, namely, intraband transitions of photogenerated electrons and holes that are accompanied by absorption of even more photons. This limits the power that can be supported by a silicon waveguide (or other silicon-based optical elements) and, in turn, results in a saturation of the power of the transmitted lidar beams.

Aspects and implementations of the present disclosure enable methods and systems that reduce the amount of power lost in semiconducting optical devices and significantly increase the maximum power that can be outputted by PIC-based lidar devices. More specifically, a silicon-based optical element (e.g., waveguide, optical switch, optical modulator, phase shifter, and the like) can be manufactured to have extraction electrodes positioned on opposite sides of the device. For example, one electrode can be a p-doped semiconducting island (e.g., made of the same material that is used in the optical element itself) and another electrode can be an n-doped semiconducting island. Correspondingly, the optical device, with the undoped semiconductor (e.g., silicon) sandwiched between the p-doped island and the n-doped island operates as a p-i-n semiconductor/insulator/semiconductor junction. A reverse bias applied to the doped islands of the p-i-n junction can sweep charge carriers from the undoped region to the doped islands (e.g., sweeping electrons into the n-doped island and sweeping holes into the p-doped island). Such a continuous extraction of photogenerated carriers prevents the central undoped region from collecting a large number of carriers in the conduction and valence bands and thus suppresses intraband optical absorption of the beam propagating in the undoped region.

Suppression of optical absorption enables propagation of high-power light in PICs. To engineer the high-power light to desired characteristics, additional control over the light can be facilitated by heating electrodes positioned in proximity to the waveguides (or other optical elements), through the thermo-optic effect that results in a dependence of the refractive index n on temperature T. For example, thermo-optic effect in silicon, dn/dT≈1.86×10⁻⁴ K⁻¹ enables to add a π shift to the phase of light over 0.1 mm distance of travel by using a 50° C. electrically-induced temperature change. As described herein, a combination of carrier extraction electrodes and heating electrodes enables configuring PICs to support various optical components and devices for controlling high-power lidar beams, e.g., optical modulators, optical switches, phase shifter, and any other PIC elements that operate by inducing temperature-controlled phase changes. In one example implementation, one or more waveguides with photocarrier extraction can guide a high-power TX beam to an optical interface that outputs the TX beam to outer space. A modulator with heating electrode-controlled temperature and carrier extraction can impart a desired phase modulation to the TX beam. A fabric of optical switches can direct the TX beam to a desired optical interface (or multiple optical interfaces). Optical switches can use the Mach-Zehnder interferometer setup in which the TX beam is split into multiple (e.g., two) portions (arms) that are imparted different phase shifts (e.g., by passing the portions through waveguides with different temperatures) and steering the recombined beam using the imparted phase shifts to different output ports of the switch. Numerous other implementations are disclosed herein.

The advantages of the disclosed implementations include, but are not limited to, generation and control of high-power lidar beams. High-power lidar beams increase the maximum range of lidar sensing and improve efficiency and accuracy of lidar speed and velocity detections. This, in turn, improves safety of lidar-based applications, such as autonomous vehicle driving missions. Additionally, increased power of lidar beams enables faster image acquisition (since collecting a sufficient number of returned photons from a given target takes less time) and, therefore, acquiring a larger number of returned points.

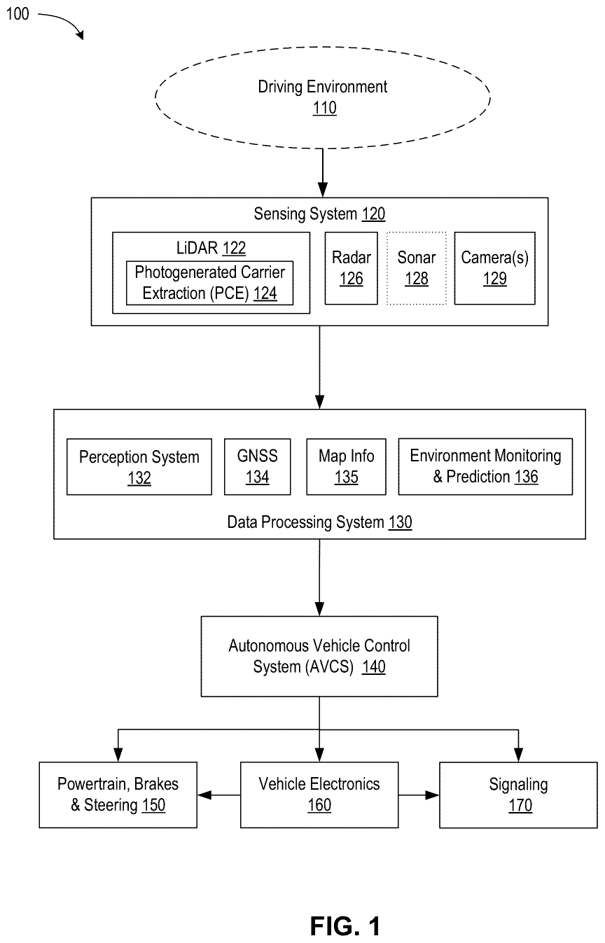

FIG. 1 is a diagram illustrating components of an example autonomous vehicle (AV) 100 that deploys a lidar device capable of supporting high-power sensing beams by implementing carrier extraction of photogenerated carriers from light guiding media and various optical elements, in accordance with some implementations of the present disclosure. Autonomous vehicles can include motor vehicles (cars, trucks, buses, motorcycles, all-terrain vehicles, recreational vehicle, any specialized farming or construction vehicles, and the like), aircraft (planes, helicopters, drones, and the like), naval vehicles (ships, boats, yachts, submarines, and the like), or any other self-propelled vehicles (e.g., robots, factory or warehouse robotic vehicles, and sidewalk delivery robotic vehicles) capable of being operated in a self-driving mode (without a human input or with a reduced human input).

Vehicles, such as those described herein, may be configured to operate in one or more different driving modes. For instance, in a manual driving mode, a driver may directly control acceleration, deceleration, and steering via inputs such as an accelerator pedal, a brake pedal, a steering wheel, etc. A vehicle may also operate in one or more autonomous driving modes including, for example, a semi or partially autonomous driving mode in which a person exercises some amount of direct or remote control over driving operations, or a fully autonomous driving mode in which the vehicle handles the driving operations without direct or remote control by a person. These vehicles may be known by different names including, for example, autonomously driven vehicles, self-driving vehicles, and so on.

As described herein, in a semi or partially autonomous driving mode, even though the vehicle assists with one or more driving operations (e.g., steering, braking and/or accelerating to perform lane centering, adaptive cruise control, advanced driver assistance systems (ADAS), and emergency braking), the human driver is expected to be situationally aware of the vehicle's surroundings and supervise the assisted driving operations. Here, even though the vehicle may perform all driving tasks in certain situations, the human driver is expected to be responsible for taking control as needed.

Although, for brevity and conciseness, various systems and methods are described below in conjunction with autonomous vehicles, similar techniques can be used in various driver assistance systems that do not rise to the level of fully autonomous driving systems. In the United States, the Society of Automotive Engineers (SAE) have defined different levels of automated driving operations to indicate how much, or how little, a vehicle controls the driving, although different organizations, in the United States or in other countries, may categorize the levels differently. More specifically, disclosed systems and methods can be used in SAE Level 2 driver assistance systems that implement steering, braking, acceleration, lane centering, adaptive cruise control, etc., as well as other driver support. The disclosed systems and methods can be used in SAE Level 3 driving assistance systems capable of autonomous driving under limited (e.g., highway) conditions. Likewise, the disclosed systems and methods can be used in vehicles that use SAE Level 4 self-driving systems that operate autonomously under most regular driving situations and require only occasional attention of the human operator. In all such driving assistance systems, accurate lane estimation can be performed automatically without a driver input or control (e.g., while the vehicle is in motion) and result in improved reliability of vehicle positioning and navigation and the overall safety of autonomous, semi-autonomous, and other driver assistance systems. As previously noted, in addition to the way in which SAE categorizes levels of automated driving operations, other organizations, in the United States or in other countries, may categorize levels of automated driving operations differently. Without limitation, the disclosed systems and methods herein can be used in driving assistance systems defined by these other organizations' levels of automated driving operations.

A driving environment 110 can be or include any portion of the outside environment containing objects that can determine or affect how driving of the AV occurs. More specifically, a driving environment 110 can include any objects (moving or stationary) located outside the AV, such as roadways, buildings, trees, bushes, sidewalks, bridges, mountains, other vehicles, pedestrians, bicyclists, and so on. The driving environment 110 can be urban, suburban, rural, and so on. In some implementations, the driving environment 110 can be an off-road environment (e.g. farming or agricultural land). In some implementations, the driving environment can be inside a structure, such as the environment of an industrial plant, a shipping warehouse, a hazardous area of a building, and so on. In some implementations, the driving environment 110 can consist mostly of objects moving parallel to a surface (e.g., parallel to the surface of Earth). In other implementations, the driving environment can include objects that are capable of moving partially or fully perpendicular to the surface (e.g., balloons, and leaves falling). The term “driving environment” should be understood to include all environments in which motion of self-propelled vehicles can occur. For example, “driving environment” can include any possible flying environment of an aircraft or a marine environment of a naval vessel. The objects of the driving environment 110 can be located at any distance from the AV, from close distances of several feet (or less) to several miles (or more).

The example AV 100 can include a sensing system 120. The sensing system 120 can include various electromagnetic (e.g., optical) and non-electromagnetic (e.g., acoustic) sensing subsystems and/or devices. The terms “optical” and “light,” as referenced throughout this disclosure, are to be understood to encompass any electromagnetic radiation (waves) that can be used in object sensing to facilitate autonomous driving, e.g., distance sensing, velocity sensing, acceleration sensing, rotational motion sensing, and so on. For example, “optical” sensing can utilize a range of light visible to a human eye (e.g., the 380 to 700 nm wavelength range), the UV range (below 380 nm), the infrared range (above 700 nm), the radio frequency range (above 1 m), etc. In implementations, “optical” and “light” can include any other suitable range of the electromagnetic spectrum.

The sensing system 120 can include a radar unit 126, which can be any system that utilizes radio or microwave frequency signals to sense objects within the driving environment 110 of the AV 100. Radar unit 126 may deploy a sensing technology that is similar to the lidar technology but uses a radio wave spectrum of the electromagnetic waves. For example, radar unit 126 may use 10-100 GHz carrier radio frequencies. Radar unit 126 may be a pulsed ToF radar, which detects a distance to the objects from the time of signal propagation, or a continuously-operated coherent radar, which detects both the distance to the objects as well as the velocities of the objects, by determining a phase difference between transmitted and reflected radio signals. Compared with lidars, radar sensing units have lower spatial resolution (by virtue of a much longer wavelength), but lack expensive optical elements, are easier to maintain, have a longer working range, and are less sensitive to adverse weather conditions. An AV may often be outfitted with multiple radar transmitters and receivers as part of the radar unit 126. The radar unit 126 can be configured to sense both the spatial locations of the objects (including their spatial dimensions) and their velocities (e.g., using the radar Doppler shift technology). The sensing system 120 can include a lidar sensor 122 (e.g., a lidar rangefinder), which can be a laser-based unit capable of determining distances to the objects in the driving environment 110 as well as, in some implementations, velocities of such objects. The lidar sensor 122 can utilize wavelengths of electromagnetic waves that are shorter than the wavelength of the radio waves and can thus provide a higher spatial resolution and sensitivity compared with the radar unit 126. The lidar sensor 122 can include a ToF lidar and/or a coherent lidar sensor, such as a frequency-modulated continuous-wave (FMCW) lidar sensor, phase-modulated lidar sensor, amplitude-modulated lidar sensor, and the like. Coherent lidar sensors can use optical heterodyne detection for velocity determination. In some implementations, the functionality of the ToF lidar sensor and coherent lidar sensor can be combined into a single (e.g., hybrid) unit capable of determining both the distance to and the radial velocity of the reflecting object. Such a hybrid unit can be configured to operate in an incoherent sensing mode (ToF mode) and/or a coherent sensing mode (e.g., a mode that uses heterodyne detection) or both modes at the same time. In some implementations, multiple lidar sensor units can be mounted on an AV, e.g., at different locations separated in space, to provide additional information about a transverse component of the velocity of the reflecting object.

Lidar sensor 122 can include one or more laser sources producing and emitting signals and one or more detectors of the signals reflected back from the objects. Lidar sensor 122 can include spectral filters to filter out spurious electromagnetic waves having wavelengths (frequencies) that are different from the wavelengths (frequencies) of the emitted signals. In some implementations, lidar sensor 122 can include directional filters (e.g., apertures, diffraction gratings, and so on) to filter out electromagnetic waves that can arrive at the detectors along directions different from the reflection directions for the emitted signals. Lidar sensor 122 can use various other optical components (lenses, mirrors, gratings, optical films, interferometers, spectrometers, local oscillators, and the like) to enhance sensing capabilities of the sensors.

In some implementations, lidar sensor 122 can include one or more 360-degree scanning units (which scan the outside environment in a horizontal direction, in one example). In some implementations, lidar sensor 122 can be capable of spatial scanning along both the horizontal and vertical directions. In some implementations, the field of view can be up to 90 degrees in the vertical direction (e.g., with at least a part of the region above the horizon scanned by the lidar signals or with at least part of the region below the horizon scanned by the lidar signals). In some implementations (e.g., in aeronautical environments), the field of view can be a full sphere (consisting of two hemispheres). For brevity and conciseness, when a reference to “lidar technology,” “lidar sensing,” “lidar data,” and “lidar,” in general, is made in the present disclosure, such reference shall be understood also to encompass other sensing technology that operate, generally, at the near-infrared wavelength, but can include sensing technology that operate at other wavelengths as well.

Lidar sensor 122 can have a photogenerated carrier extraction (PCE) 124 functionality that uses a plurality of extraction electrodes in conjunction with various optical elements, e.g., waveguides, modulators, switches, diffraction gratings, phase shifters, and any other elements implemented in semiconducting materials. In some instances, PCE 124 can include extraction electrodes separately provided to individual elements, such that specific desired voltages can be applied to different elements. In some instances, extraction electrodes can be provided to an entire group of multiple optical elements, such that the same extraction current can flow across all elements of the group. Although such sharing of the extraction functionality can reduce the amount of control over individual elements of the system (e.g., PIC), the advantages can include a simpler system design with fewer electrical wires and connections. Extraction electrodes can be provided to any or all elements that guide or modify high-intensity beams (e.g., TX beams) and can be absent in elements that handle low-power beams (e.g., reflected beams, local oscillator beams, and the like), e.g., to save manufacturing costs. In some implementations, the electric current flowing through the extraction electrodes can be measured and used to estimate the power of the beam(s), with higher currents representative of a higher density of photocarriers and, correspondingly, of a higher power of the beam(s). In some implementations, the voltages applied to the extraction electrodes can be used to control the power of the beam(s), with low applied voltages resulting in a lower maximum beam power (being limited by a high photocarrier density) and higher applied voltages resulting in an increased beam power (due to more efficient extraction of photocarriers). In some instances, PCE 124 can also include heating electrodes provided to various active optical elements, e.g., optical switches, optical modulators, phase shifters, and the like, that manipulate light by imparting temperature-controlled phase shifts to the light, e.g., for channeling the light along desired optical paths, inducing or changing phase modulation of the light, and so on.

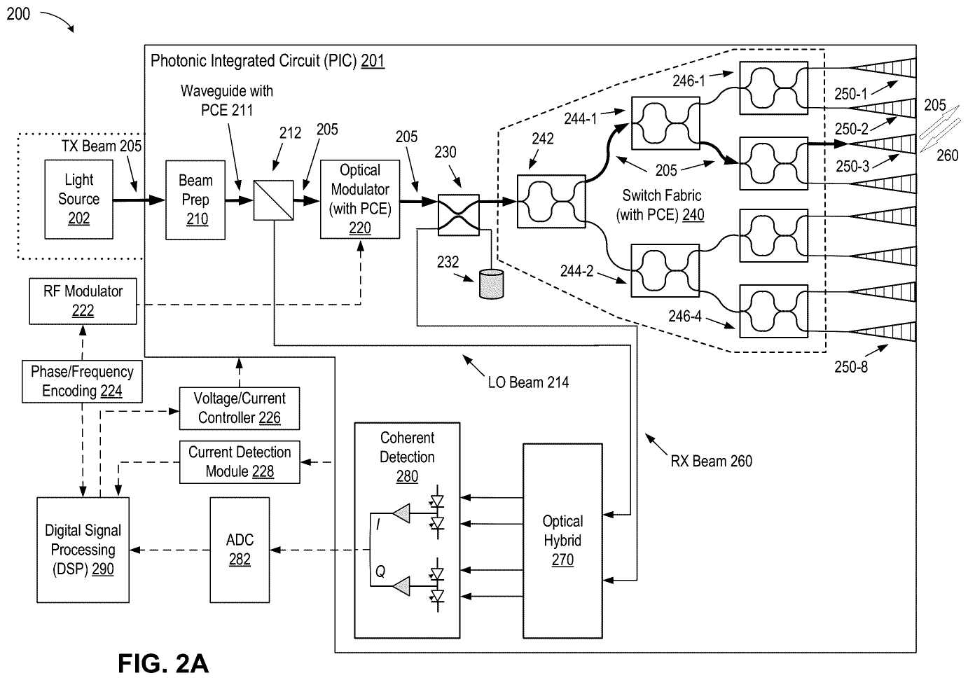

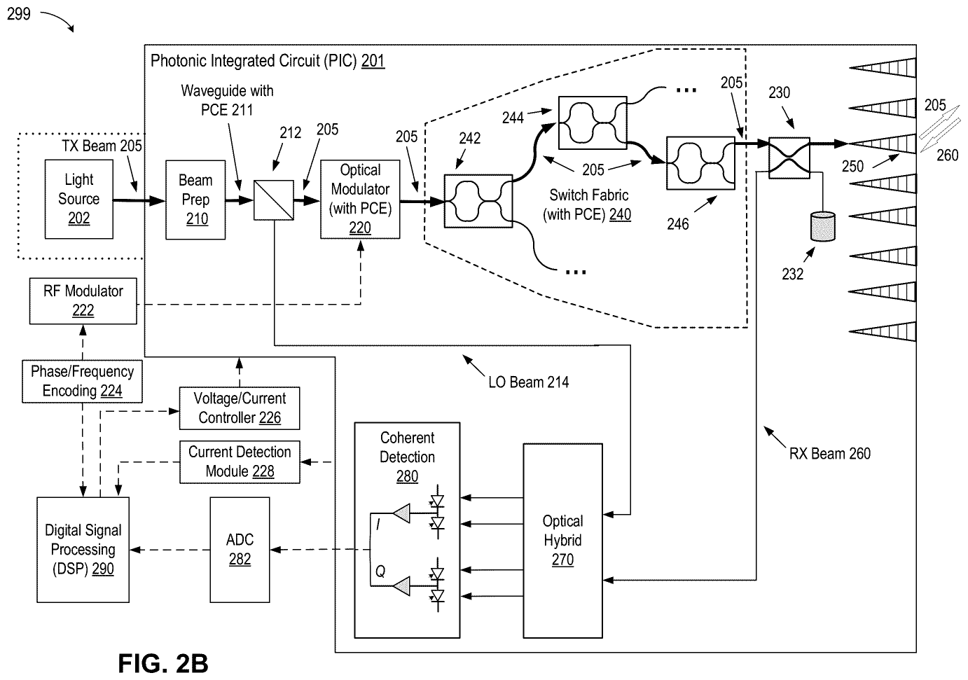

The electronic circuitry of PCE 124 can include power supplies, voltage-control circuitry (e.g., for biasing the extraction electrodes to a desired voltage), current-control circuitry (e.g., for driving a desired current through heating electrodes), current-detection circuitry (e.g., for estimating beam power by measuring currents of extracted carriers), and so on. The electronic circuitry of PCE 124 can further include digital signal processing, analog-to-digital converters, digital-to-analog converters, radio frequency (RF) signal generators, and any other suitable circuits. Additional elements of PCE 124 and various combinations of such elements are further illustrated in conjunction with FIGS. 2-5 below.

The sensing system 120 can further include one or more cameras 129 to capture images of the driving environment 110. The images can be two-dimensional projections of the driving environment 110 (or parts of the driving environment 110) onto a projecting plane of the cameras (flat or non-flat, e.g. fisheye cameras). Some of the cameras 129 of the sensing system 120 can be video cameras configured to capture a continuous (or quasi-continuous) stream of images of the driving environment 110. Some of the cameras 129 of the sensing system 120 can be high resolution cameras (RRCs) and some of the cameras 129 can be surround view cameras (SVCs). The sensing system 120 can also include one or more sonars 128, which can be ultrasonic sonars, in some implementations.

The sensing data obtained by the sensing system 120 can be processed by a data processing system 130 of AV 100. In some implementations, the data processing system 130 can include a perception system 132. Perception system 132 can be configured to detect and track objects in the driving environment 110 and to recognize/identify the detected objects. For example, the perception system 132 can analyze images captured by the cameras 129 and can be capable of detecting traffic light signals, road signs, roadway layouts (e.g., boundaries of traffic lanes, topologies of intersections, designations of parking places, and so on), presence of obstacles, and the like. The perception system 132 can further receive the lidar sensing data (Doppler data and/or ToF data) to determine distances to various objects in the driving environment 110 and velocities (radial and transverse) of such objects. In some implementations, the perception system 132 can also receive the radar sensing data, which may similarly include distances to various objects as well as velocities of those objects. Radar data can be complementary to lidar data, e.g., whereas lidar data may high-resolution data for low and mid-range distances (e.g., up to several hundred meters), radar data may include lower-resolution data collected from longer distances (e.g., up to several kilometers or more). In some implementations, perception system 132 can use the lidar data and/or radar data in combination with the data captured by the camera(s) 129. In one example, the camera(s) 129 can detect an image of road debris partially obstructing a traffic lane. Using the data from the camera(s) 129, perception system 132 can be capable of determining the angular extent of the debris. Using the lidar data, the perception system 132 can determine the distance from the debris to the AV and, therefore, by combining the distance information with the angular size of the debris, the perception system 132 can determine the linear dimensions of the debris as well.

In another implementation, using the lidar data, the perception system 132 can determine how far a detected object is from the AV and can further determine the component of the object's velocity along the direction of the AV's motion. Furthermore, using a series of quick images obtained by the camera, the perception system 132 can also determine the lateral velocity of the detected object in a direction perpendicular to the direction of the AV's motion. In some implementations, the lateral velocity can be determined from the lidar data alone, for example, by recognizing an edge of the object (using horizontal scanning) and further determining how quickly the edge of the object is moving in the lateral direction. The perception system 132 can receive one or more sensor data frames from the sensing system 120. Each of the sensor frames can include multiple points. Each point can correspond to a reflecting surface from which a signal emitted by the sensing system 120 (e.g., lidar sensor 122) is reflected. The type and/or nature of the reflecting surface can be unknown. Each point can be associated with various data, such as a timestamp of the frame, coordinates of the reflecting surface, radial velocity of the reflecting surface, intensity of the reflected signal, and so on.

The perception system 132 can further receive information from a positioning subsystem, which can include a GPS transceiver (not shown), configured to obtain information about the position of the AV relative to Earth and its surroundings. The GNSS (or other positioning) data processing module 134 can use the positioning data (e.g., GNSS, GPS, and IMU data) in conjunction with the sensing data to help accurately determine the location of the AV with respect to fixed objects of the driving environment 110 (e.g. roadways, lane boundaries, intersections, sidewalks, crosswalks, road signs, curbs, and surrounding buildings) whose locations can be provided by map information 135. In some implementations, the data processing system 130 can receive non-electromagnetic data, such as audio data (e.g., ultrasonic sensor data, or data from a mic picking up emergency vehicle sirens), temperature sensor data, humidity sensor data, pressure sensor data, meteorological data (e.g., wind speed and direction, precipitation data), and the like.

Data processing system 130 can further include an environment monitoring and prediction component 136, which can monitor how the driving environment 110 evolves with time, e.g., by keeping track of the locations and velocities of the moving objects. In some implementations, environment monitoring and prediction component 136 can keep track of the changing appearance of the driving environment due to motion of the AV relative to the environment. In some implementations, driving environment monitoring and prediction component 136 can make predictions about how various moving objects of the driving environment 110 will be positioned within a prediction time horizon. The predictions can be based on the current locations and velocities of the moving objects as well as on the tracked dynamics of the moving objects during a certain (e.g., predetermined) period of time. For example, based on stored data for object 1 indicating accelerated motion of object 1 during the previous 3-second period of time, environment monitoring and prediction component 136 can conclude that object 1 is resuming its motion from a stop sign or a red traffic light signal. Accordingly, environment monitoring and prediction component 136 can predict, given the layout of the roadway and presence of other vehicles, where object 1 is likely to be within the next 3 or 5 seconds of motion. As another example, based on stored data for object 2 indicating decelerated motion of object 2 during the previous 2-second period of time, environment monitoring and prediction component 136 can conclude that object 2 is stopping at a stop sign or at a red traffic light signal. Accordingly, environment monitoring and prediction component 136 can predict where object 2 is likely to be within the next 1 or 3 seconds. Environment monitoring and prediction component 136 can perform periodic checks of the accuracy of its predictions and modify the predictions based on new data obtained from the sensing system 120.

The data generated by the perception system 132, the GNSS data processing module 134, and environment monitoring and prediction component 136 can be used by an autonomous driving system, such as AV control system (AVCS) 140. The AVCS 140 can include one or more algorithms that control how AV 100 is to behave in various driving situations and driving environments. For example, the AVCS 140 can include a navigation system for determining a global driving route to a destination point. The AVCS 140 can also include a driving path selection system for selecting a particular path through the immediate driving environment, which can include selecting a traffic lane, negotiating a traffic congestion, choosing a place to make a U-turn, selecting a trajectory for a parking maneuver, and so on. The AVCS 140 can also include an obstacle avoidance system for safe avoidance of various obstructions (rocks, stalled vehicles, a jaywalking pedestrian, and so on) within the driving environment of the AV. The obstacle avoidance system can be configured to evaluate the size, shape, and trajectories of the obstacles (if obstacles are moving) and select an optimal driving strategy (e.g., braking, steering, and accelerating) for avoiding the obstacles.

Algorithms and modules of AVCS 140 can generate instructions for various systems and components of the vehicle, such as the powertrain, brakes, and steering 150, vehicle electronics 160, signaling 170, and other systems and components not explicitly shown in FIG. 1. The powertrain, brakes, and steering 150 can include an engine (internal combustion engine, electric engine, etc.), transmission, differentials, axles, wheels, steering mechanism, and other systems. The vehicle electronics 160 can include an on-board computer, engine management, ignition, communication systems, carputers, telematics, in-car entertainment systems, and other systems and components. The signaling 170 can include high and low headlights, stopping lights, turning and backing lights, horns and alarms, inside lighting system, dashboard notification system, passenger notification system, radio and wireless network transmission systems, and so on. Some of the instructions outputted by the AVCS 140 can be delivered directly to the powertrain, brakes, and steering 150 (or signaling 170) whereas other instructions outputted by the AVCS 140 are first delivered to the vehicle electronics 160, which generate commands to the powertrain and steering 150 and/or signaling 170.

In one example, the AVCS 140 can determine that an obstacle identified by the data processing system 130 is to be avoided by decelerating the vehicle until a safe speed is reached, followed by steering the vehicle around the obstacle. The AVCS 140 can output instructions to the powertrain, brakes, and steering 150 (directly or via the vehicle electronics 160) to 1) reduce, by modifying the throttle settings, a flow of fuel to the engine to decrease the engine rpm, 2) downshift, via an automatic transmission, the drivetrain into a lower gear, 3) engage a brake unit to reduce (while acting in concert with the engine and the transmission) the vehicle's speed until a safe speed is reached, and 4) perform, using a power steering mechanism, a steering maneuver until the obstacle is safely bypassed. Subsequently, the AVCS 140 can output instructions to the powertrain, brakes, and steering 150 to resume the previous speed settings of the vehicle.

FIG. 2A is a block diagram illustrating an example implementation of an optical sensing system 200 that deploys photogenerated carrier extraction, in accordance with some implementations of the present disclosure. Optical sensing system 200 can be a part of a (high-power) lidar sensor 122. Depicted in FIG. 2A is a light source 202 configured to produce one or more beams of light. “Beams” should be understood herein as referring to any signals of electromagnetic radiation, such as beams, wave packets, pulses, sequences of pulses, or other types of signals. Solid arrows in FIG. 2A (and other figures) indicate optical signal propagation whereas dashed arrows depict propagation of electrical (e.g., RF or other analog) signals or electronic (e.g., digital) signals. Light source 202 can be a broadband laser, a narrow-band laser, a light-emitting diode, and the like. Light source 202 can be a semiconductor laser, a gas laser, an ND:YAG laser, a quantum dot laser, or any other type of a laser. Light source 202 can be a continuous wave laser, a single-pulse laser, a repetitively pulsed laser, a mode locked laser, and the like.

A beam of light produced by light source 202 can be delivered, e.g., via an optical fiber or free space, to PIC 201 for further processing. In some implementations, as depicted with the dotted line, light source 202 can be a light source (e.g., semiconducting laser, and laser diode) that is integrated into PIC 201. PIC 201 can perform multiple passive and active optical functions to create one or more signals with desired amplitude, phase, spectral, and polarization characteristics. PIC 201 can include a number of waveguides, beam splitters, couplers, light switches, phase shifters, optical amplifiers, diffraction gratings, grating couplers, photodiodes, and other optical elements. The beam produced by light source 202 can be received by PIC 201 using one or more directional switches that direct the incoming light within the plane of a chip, e.g., into a silicon (or any other suitable semiconducting material) single-mode or multi-mode waveguide(s).

In some implementations, light outputted by light source 202 can be conditioned (pre-processed) by one or more components or elements of a beam preparation stage 210 of the optical sensing system 200 to ensure a narrow-band spectrum, target linewidth, coherence, polarization (e.g., circular or linear), and other optical properties that enable coherent (e.g., Doppler) measurements described below. Although shown as part of PIC 201, in some implementations, some or all operations of beam preparation stage 210 can be performed outside PIC 201 with the preprocessed light being delivered to PIC 201 as described above. Beam preparation can be performed using filters (e.g., narrow-band filters), resonators (e.g., resonator cavities, and crystal resonators), polarizers, feedback loops, lenses, mirrors, diffraction optical elements, and other optical devices. For example, if light source 202 is a broadband light source, the output light can be filtered to produce a narrowband beam. In some implementations, in which light source 202 produces light that has a desired linewidth and coherence, the light can still be additionally filtered, focused, collimated, diffracted, amplified, polarized, etc., to produce one or more beams of a desired spatial profile, spectrum, duration, frequency, polarization, repetition rate, and so on. In some implementations, light source 202 can produce (alone or in combination with beam preparation stage 210) a narrow-linewidth light with a linewidth below 100 KHz. The beam of light produced by beam preparation stage 210 is referred to as a transmitted beam (TX) beam 205, although it should be understood that TX beam 205 can still undergo multiple modifications, as described below (and indicated with thick arrows in FIG. 2A), before being actually transmitted to the outside environment.

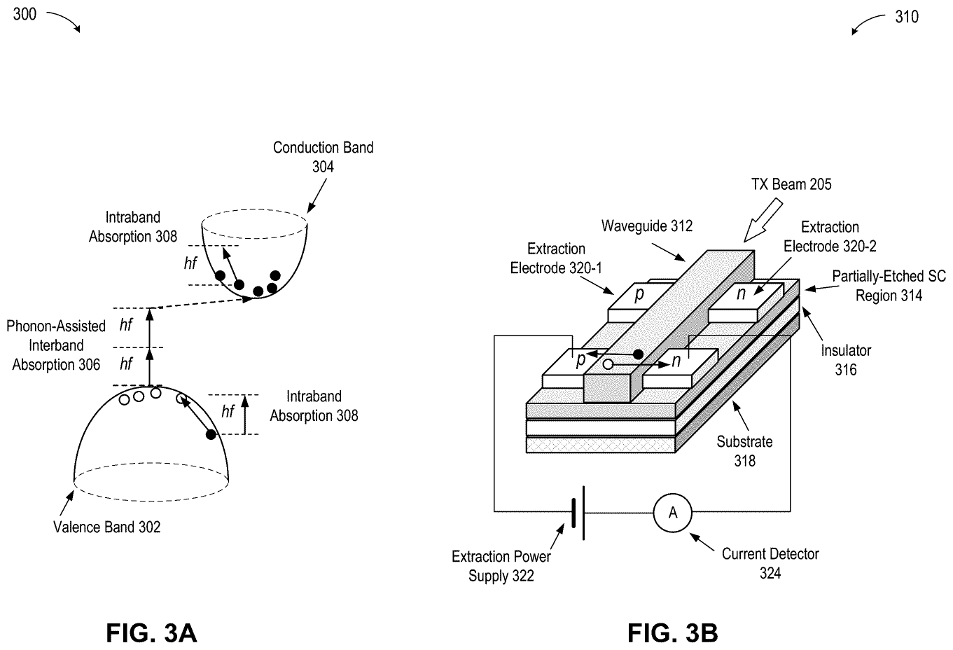

In some implementations, TX beam 205 can be a high-power beam. “High-power” beam should be understood as a light of any intensity for which power losses due to photogeneration of charge carriers in materials used in PIC 201 for transporting and modifying light becomes of comparable magnitude to the power of TX beam 205 itself, e.g., 50% of the power of TX beam 205, or any other similar threshold. The high-power TX beam 205 can be delivered to a beam splitter 212 using a waveguide 211. Waveguide 211 can be any semiconductor waveguide augmented with carrier extraction electrodes, as described below in conjunction with FIGS. 3-5. Beam splitter 212 splits a portion of TX beam 205 to form a local oscillator (LO) beam 214 that is used as a reference signal to which the signal reflected from a target object is compared. The beam splitter 212 can be a power splitter, a multimode interference splitter, a directional coupler, a waveguide integrated with a subwavelength diffraction grating, or any other suitable device. The beam splitter can be a 90:10 or 80:20 beam splitter with the LO beam 214 carrying a small portion of the total energy of the generated light beam. Correspondingly, LO beam 214 can be a low-power beam and can be transported within PIC 201 using conventional waveguides that are not augmented with carrier extraction electrodes, to save costs. In some implementations, waveguides that guide LO beam 214 (and any other low-power beams, e.g., received beam) can nonetheless be augmented with carrier extraction electrodes.

An optical modulator 220 can receive the rest of TX beam 205 transmitted by the beam splitter 212 and can impart optical modulation to TX beam 205. “Optical modulation” is to be understood herein as referring to any form of angle modulation, such as phase modulation (e.g., any sequence of phase changes Δϕ(t) as a function of time t that are added to the phase of the beam), frequency modulation (e.g., any sequence of frequency changes Δf(t) as a function of time t), or any other type of modulation (including a combination of a phase and a frequency modulation) that affects the phase of the wave. Optical modulation is also to be understood to include, where applicable, amplitude modulation ΔA(t) as a function of time t Amplitude modulation can be applied to light in combination with angle modulation or separately, without angle modulation.

In some implementations, optical modulator 220 can impart angle modulation to TX beam 205 using one or more RF circuits, such as RF modulator 222, which can include one or more RF local oscillators, mixers, amplifiers, filters, and the like. Even though, for brevity and conciseness, modulation is referred to herein as being performed with RF signals, it should be understood that other frequencies can also be used for angle modulation, including but not limited to Terahertz frequencies, microwave frequencies, and so on. RF modulator 222 can impart optical modulation in accordance with a programmed modulation scheme, e.g., encoded in a sequence of control signals provided by a phase/frequency encoding module (herein also referred to, for simplicity, as encoding module) 224. The control signals can be in an analog format or a digital format. In the latter instances, RF modulator 222 can further include a digital-to-analog converter (DAC) to transform digital control signals to analog form. The encoding module 224 can implement any suitable encoding (keying), e.g., linear frequency chirps (e.g., a chirp-up/chirp-down sequence), pseudorandom keying sequence of phase Δϕ or frequency Δf shifts, and the like. The encoding module 224 can provide the encoding data to RF modulator 222 that can convert the provided data to RF electrical signals and apply the RF electrical signals to optical modulator 220 that modulates TX beam 205.

In some implementations, optical modulator 220 can include an acousto-optic modulator (AOM), an electro-optic modulator (EOM), a Lithium Niobate modulator, a heat-driven modulator, a Mach-Zehnder modulator, and the like, or any combination thereof. In some implementations, optical modulator 220 can include a quadrature amplitude modulator (QAM) or an in-phase/quadrature modulator (IQM). Optical modulator 220 can include multiple AOMs, EOMs, IQMs, one or more beam splitters, phase shifters, combiners, and the like. For example, optical modulator 220 can split TX beam 205 into two beams, modify a phase of one of the split beams (e.g., by a 90-degree phase shift), and pass each of the two split beams through a separate optical modulator to apply angle modulation to each of the two beams using a target encoding scheme. The two beams can then be recombined into a single beam. In some implementations, angle modulation can add phase/frequency shifts that are continuous functions of time. In some implementations, added phase/frequency shifts can be discrete and can take on a number of values, e.g., N discrete values across the phase interval 27r (or across a frequency band of a predefined width). Optical modulator 220 can add a predetermined time sequence of the phase/frequency shifts to TX beam 205. In some implementations, a modulated RF signal can cause optical modulator 220 to impart to TX beam 205 a sequence of frequency up-chirps interspersed with down-chirps. In some implementations, phase/frequency modulation can have a duration between a microsecond and tens of microseconds and can be repeated with a repetition rate ranging from one or several kilohertz to hundreds of kilohertz. Any suitable amplifier (not shown in FIG. 2A for conciseness) can amplify the modulated TX beam 205. In some implementations, optical modulator 220 can use photogenerated carrier extraction techniques, as described below in conjunction with FIGS. 3-5.

TX beam 205 modulated by optical modulator 220 can be delivered to a directional coupler 230 that can split TX beam 205 into multiple beams. Directional coupler 230 can be configured to serve as a separator of TX beam 205 and a received (RX) beam 260 generated upon interaction of TX beam 205 with a target in the outside environment. More specifically, rightward (downstream) of directional coupler 230, TX beam 205 and RX beam 260 can follow the same optical path whereas leftward (upstream) of directional coupler 230, TX beam 205 and RX beam 260 can follow different optical paths. In particular, directional coupler 230 can receive TX beam 205 on the coupler's input port and transmit a portion of TX beam 205 towards an optical switch 242. The remaining portion of TX beam 205 outputted by the coupled port of directional coupler 230 can be received by a light stop (absorber) 232. Under ideal conditions, the fourth (isolated) port of directional coupler 230 leaks no or very little light. In some implementations, a suitable optical circulator can perform the function of separating TX beam 205 from RX beam 260 instead of directional coupler 230.

TX beam 205 can then be guided to one or more interface couplers 250-m that output the TX beam into the outside environment. Although eight interface couplers 250-1, 250-2 . . . 250-8 are shown in FIG. 2A, any other number of interface couplers can be supported by a single PIC. Guiding of TX beam 205 can be performed using one (in case of two interface couplers 250-m) or a plurality (if more than two interface couplers 250-m are used) of optical switches, which can be joined in a switch fabric (switch network) 240. For example, as illustrated in FIG. 2A, optical switch 242 can direct TX beam 205 towards one of optical switches 244-1 or 244-2, which in turn can direct TX beam 205 to one of optical switches 446-1 . . . 246-4, which can then direct TX beam 205 to one of interface couplers 250-1 . . . 250-8. Though three levels of optical switches are shown in FIG. 2A, in various implementations, switch fabric 240 can have any other number of levels and branches of optical switches.

In some implementations, optical switches of the switch fabric 240 can be of Mach-Zehnder interferometer type. For example, a beam (e.g., TX beam 205) inputted into an optical switch, e.g., optical switch 242, can be split into two (or more) arms, e.g., with each arm carrying an equal portion of the input beam's power. Each arm can include a waveguide that is independently heated by a respective heating electrode. As a result, each waveguide equipped with the heating electrode performs the function of a phase controller (phase shifter). A voltage/current controller 226 can drive a current through one of the heating electrodes to cause one of the arms of the input beam to acquire a controlled phase shift. Voltage/current controller 226 can compute the phase shift in such a way that when the two arms recombine (e.g., in a 2×2 output coupler), the arms interfere constructively for the path leading towards optical switch 244-1 and interfere destructively for the path leading towards optical switch 244-2 (or vice versa). Other optical switches of the switch fabric 240 can operate in a similar fashion. Consequently, TX beam 205 can be delivered to any of the interface couplers 250-1 . . . 250-8. Each of interface couplers 250-1 . . . 250-8 can be positioned (or otherwise configured, by having slightly different properties, e.g., diffraction grating spacing) to point TX beam 205 along a different direction in the outside environment. In some implementations, the interface couplers 250-m can be grating couplers or any other suitable directional switches configured to direct TX beams along the desired directions in space. Each interface coupler can implement a different sensing pixel corresponding to a respective spatial direction probed by optical sensing system 200.

In the example configuration depicted in FIG. 2A, voltage/current controller 226 has configured optical switches of the switch fabric 240 to direct TX beam 205 to interface coupler 250-3. In some implementations, switch fabric 240 can direct a copy of TX beam 205 to more than one interface coupler 250-m, including (in some instances) all interface couplers 250-m. To compensate for the resulting reduction of the power of each transmitted beam, switch fabric 240 can include one or more amplifiers (not shown for brevity in FIG. 2A) to increase the power of the transmitted beams. The amplifiers can be positioned between different optical switches and/or between optical switches 246-1 . . . 246-4 and interface couplers 250-1 . . . 250-8. The amplifier(s) can be active gain medium amplifiers, semiconductor optical amplifiers (e.g., doped-semiconductor amplifiers), parametric amplifiers, and the like, or some combination thereof.

Each of the optical switches of switch fabric 240 can be augmented with carrier extraction electrodes for high-power beam operations. More specifically, voltage/current controller 226 can deliver an appropriate voltage (potential) to each extraction electrode to ensure that semiconductor waveguides (and/or other optical elements) of each optical switch are drained of the photogenerated carriers induced therein. In some implementations, multiple optical switches can be drained together. For example, all waveguides of optical switches 244-1 and 244-2 can be drained of photogenerated carriers using a single pair of electrodes that encompass all the waveguides. Similarly, any one of the waveguides (and/or other optical elements) of optical switches 246-1 . . . 246-4 may be drained of photogenerated carriers using a dedicated pair of electrodes. In some implementations, each optical switch can have a dedicated pair of carrier extraction electrodes, so that the voltage/current controller provides voltages only to those optical switches that are guiding actual light beams. For example, in the configuration of the switch fabric 240 shown in FIG. 2A, extraction electrodes of the inactive optical switches 246-1, 244-2, as well as both optical switches positioned downstream of optical switch 244-2 need not be biased by voltage/current controller 226.

In some implementations, a current detection module 228 can measure electric current of the extracted photogenerated carriers and estimate power P of TX beam 205 carried by any specific waveguide (e.g., waveguide 211) and/or any specific optical switch. In particular, current detection module 228 can have access to calibration data that tabulates the dependence of the extracted current I(P,V) on the power and the voltage V applied to the extraction electrodes. Based on the known value of the voltage V (e.g., as set by voltage/current controller 226) and the measured current I, current detection module 228 can determine, using the calibration data, the current power P(I,V) of the beam. In some implementations, power P(I,V) can be controlled by controlling voltage V applied to the extraction electrodes.

RX beam 260 can be received through the same optical interface (e.g., optical interface 250-3) that outputs TX beam 205. RX beam 260 can follow the path of TX beam 205 through the switch fabric 240. RX beam 260 can be directed by directional coupler 230 to optical hybrid stage 270 whose second input can be LO beam 214. Optical hybrid stage 270 can perform pre-conditioning of the input beams prior to processing by a coherent detection stage 280. In some implementations, optical hybrid stage 270 can be a 180-degree hybrid stage capable of detecting the absolute value of a phase difference of the input beams. In some implementations, optical hybrid stage 270 can be a 90-degree optical hybrid stage capable of detecting both the absolute value and a sign of the phase difference of the input beams. For example, in the latter case, optical hybrid stage 270 can be designed to split each of the input beams into multiple copies (e.g., four copies, as depicted). Optical hybrid stage 270 can apply controlled phase shifts (e.g., 90°, 180°, 270°) to some of the copies, e.g., copies of LO beam 214, and mix the phase-shifted copies of LO beam 214 with RX beam 260, whose electric field is denoted with E_{RX}. As a result, the optical hybrid stage 270 can produce the in-phase symmetric and anti-symmetric combinations (E_{RX}+E_{LO})/2 and (E_{RX}−E_{LO})/2 of the input beams, and the quadrature 90-degree-shifted combinations (E_{RX}+iE_{LO})/2 and (E_{RX}−iE_{LO})/2 of the input beams (i being the imaginary unit number).

The coherent detection stage 280 receives four input combinations of E_{RX} and E_{LO} (in case of a 90-degree optical hybrid stage 270) or two combinations E_{RX}±E_{LO} (in case of a 180-degree optical hybrid stage 270). The coherent detection stage 280 then processes the received inputs using one or more coherent light analyzers, such as balanced photodetectors, to detect phase information carried by RX beam 260. A balanced photodetector can have photodiodes connected in series and can generate AC electrical signals that are proportional to a difference of intensities of the input optical modes (which can also be pre-amplified). A balanced photodetector can include photodiodes that are Si-based, InGaAs-based, Ge-based, Si-on-Ge-based, and the like (e.g. avalanche photodiode). In some implementations, balanced photodetectors can be manufactured on a single chip, e.g., using complementary metal-oxide-semiconductor (CMOS) structures, silicon photomultiplier (SiPM) devices, or similar systems. In the implementation depicted in FIG. 2A, the LO beam 214 is unmodulated, but it should be understood that in other implementations consistent with the present disclosure, LO beam 214 can be modulated. For example, optical modulator 220 can be positioned between beam preparation stage 210 and beam splitter 212 to modulate LO beam 214.

Each of the input signals can then be received by respective photodiodes connected in series. An in-phase electric current I can be produced by a first pair of the photodiodes and a quadrature current Q can be produced by a second pair of photodiodes. Each of the currents can be further processed by one or more operational amplifiers, intermediate frequency amplifiers, and the like. The in-phase I and quadrature Q currents can then be mixed into a complex photocurrent whose ac part

$$J = {\vert \frac{{E}_{R X} + {E}_{L O}}{2} \vert}^{2} - {\vert \frac{{E}_{R X} - {E}_{L O}}{2} \vert}^{2} + {\vert \frac{{E}_{R X} + i {E}_{L O}}{2} \vert}^{2} - {\vert \frac{{E}_{R X} + i {E}_{L O}}{2} \vert}^{2} = {E}_{R X} {E}_{L O}^{*}$$

is sensitive to both the absolute value and the sign of the phase difference of E_{CB} and E_{LO}. Similarly, a 180-degree optical hybrid can produce only the in-phase photocurrent whose AC part

$$J = {\vert \frac{{E}_{R X} + {E}_{L O}}{2} \vert}^{2} - {\vert \frac{{E}_{R X} - {E}_{L O}}{2} \vert}^{2} = R e {E}_{R X} {E}_{L O}^{*}$$

is sensitive to the absolute value of the phase difference but not the sign of this phase difference.

The digitized signal J(t)=E_{Ref}(t)E_{LO}*(t) is representative of a beating pattern between the LO beam 214 and RX beam 260 reflected from an object in the outside environment. More specifically, RX beam 260 E_{RX}(t) received by the optical sensing system 200 at time t was transmitted to the target at time t−τ, where τ=2L/c (the delay time) is the time of photon travel to the target located at distance L and back. DSP 290 can correlate the phase modulation in the digitized signal J(t) with the phase and/or frequency encoding (the encoding scheme can be obtained from encoding module 224) and determine the time of flight based on the time offset that ensures the optimal match between the two modulations. The distance to the object is then determined as L=cτ/2. The radial velocity of the object can be determined based on the Doppler shift f_{D} of the carrying frequency f+f_{D} of the reflected beam compared with the frequency f of LO beam 214: V=cf_{D}/(2f).

DSP 290 can include spectral analyzers, such as Fast Fourier Transform (FTT) analyzers, and other circuits configured to process digital signals, including central processing units (CPUs), graphic processing units (GPUs), field-programmable gate arrays (FPGAs), application-specific integrated circuits (ASICs), etc., and memory devices. In some implementations, the processing and memory circuits can be implemented as part of a microcontroller.

Multiple variations of the optical sensing system 200 are within the scope of the present disclosure. For example, if optical hybrid stage 270 is a 180-degree optical hybrid, the in-phase electrical signal generated by coherent detection stage 280 can be agnostic about the sign of f_{D} as Doppler-shifted beams with frequencies f+f_{D} and f−f_{D} result in the same in-phase signals. To eliminate the symmetry between the positive and negative Doppler shifts, a frequency offset f_{off} can be imparted to the TX beam 205 (or, alternatively, to LO beam 214). This disambiguates reflections from objects moving with opposite velocities +V and −V by causing the beatings between E_{RX}(t) and E_{LO}(t) to occur with frequencies f_{off}−f_{D} and f_{off}+f_{D}, having different absolute values. The offset frequency f_{off} can be applied to TX beam 205 (or LO beam 214) by an optical modulator 220 and/or additional optical modulator not shown in FIG. 2A.

FIG. 2B is a block diagram illustrating another example implementation 299 of an optical sensing system that deploys photogenerated carrier extraction, in accordance with some implementations of the present disclosure. As shown in FIG. 2B, each optical switch 242 may be supported with individual directional coupler 230 (and light stop 232) that directs TX beam 205 from respective optical switch 246 to the interface coupler 250 and receives RX beam 260 reflected from a target. For brevity and conciseness, FIG. 2B illustrates operations of a single interface coupler 250 but various other interface couplers may be operated in the same way. In some implementations, each RX beam 260 received via respective interface coupler 250 and directional coupler 230 may be processed by a dedicated coherent detection stage 280 (and optical hybrid stage 270). In some implementations, coherent detection stage 280 may receive a separate copy of LO beam 214, which may be obtained from a base LO beam via a second switch fabric (not shown in FIG. 2B).

FIGS. 3A-B illustrate example architecture and operations of an element of a photonic integrated circuit configured for extraction of charge carriers generated by a lidar transmitter beam of an optical sensing system, in accordance with some implementations of the present disclosure. FIG. 3A illustrates a physical process 300 of photogeneration of charge carriers occurring in a semiconducting material subject to a high-power electromagnetic wave. Although references below are often made to silicon, similar architecture and operations can be used to extract carriers from other semiconducting materials, e.g., Ge, GaAs, InAs, InSb, and the like. FIG. 3A depicts a top portion of a valence band 302 and a bottom portion of a conduction band 304 of an indirect bandgap semiconductor, such as silicon. Electrons from valence band 302 can absorb one or more photons with energy hf (where h is Planck's constant and f is the photon's frequency) and transition to conduction band 304. The number of photons required for the transition can depend on the relative size of the bandgap Δ and the photon energy hf. In indirect-gap semiconductors, optical absorption can also involve emission or absorption of a phonon, as indicated by the dashed arrow, to ensure quasimomentum conservation. The phonon-assisted interband absorption 306 can generate a population of electrons (depicted as black dots) in conduction band 304 and holes (depicted as white dots) in valence band 302. Additional intraband absorption 308 occurs as a result of photon absorption by photogenerated electrons in the conduction band 304 and/or photogenerated holes in the valence band 302, as depicted with solid arrows.

FIG. 3B illustrates a section 310 of a waveguide with extraction of photogenerated charge carriers to support propagation of high-power electromagnetic waves. FIG. 3B depicts TX beam 205 (or any other high-power beam) propagating along a waveguide 312 made of a semiconducting material, e.g., silicon. The semiconducting material can be intrinsic (undoped) to minimize dissipation of the power of TX beam 205. In some implementations, waveguide 312 can have a form of a rib extending above a partially-etched semiconducting (SC) region 314 of the same semiconducting material, depicted with dark shading in FIG. 3B. The semiconducting material can rest on an insulator 316 (e.g., SiO₂, or some other suitable insulator), which can be supported by an appropriate substrate (wafer) 318, e.g., a silicon substrate. Extraction electrodes 320-m can be deposited next to waveguide 312, e.g., on top of the semiconducting etched region 314. In some implementations, extraction electrodes can be made of the same semiconducting material as the waveguide 312, but can additionally be doped. For example, extraction electrode 320-1 can be p-doped (hole-doped) and extraction electrode 320-2 can be n-doped (electron-doped). The waveguide 312 and the etched region 314 can be covered with another cladding layer of the insulator (not explicitly shown in FIG. 3B for ease of viewing).

As depicted, p-doped extraction electrode 320-1, waveguide 312, and n-doped extraction electrode 320-2 make up a p-i-n junction. The p-i-n junction is capable of conducting electric current in the forward bias configuration, when a higher potential (voltage) is applied to the p-doped extraction electrode 320-1 and a lower potential (voltage) is applied to the n-doped extraction electrode 320-2. In the absence of charged carriers (electrons and hole) in the waveguide 312 (i-portion of the p-i-n junction), p-i-n junction does not conduct electric current in the reverse bias configuration, when a lower potential (voltage) is applied to the p-doped extraction electrode 320-1 and a higher potential (voltage) is applied to the n-doped extraction electrode 320-2.

As described in conjunction with FIG. 3A, propagation of TX beam 205 through waveguide 312 generates electrons and holes in the i-portion of the p-i-n junction. When an extraction power supply 322 is connected to the p-i-n junction in the reverse bias configuration, as shown in FIG. 3B, photogenerated holes from the waveguide 312 are pushed into p-doped extraction electrode 320-1 and photogenerated electrons from waveguide 312 are pushed into n-doped extraction electrode 320-2. As a result, carrier density in waveguide 312 decreases and the intraband photon absorption 308 is reduced. Stronger carrier extraction can be achieved with higher voltages V applied across the extraction electrodes 320-m. In some implementations, the extracted current I can be monitored by a suitable current detector 324, e.g., an ammeter or a galvanometer, with the power of TX beam 205 P(I,V) estimated, e.g., based on the stored calibration data for the specific device that is being used.

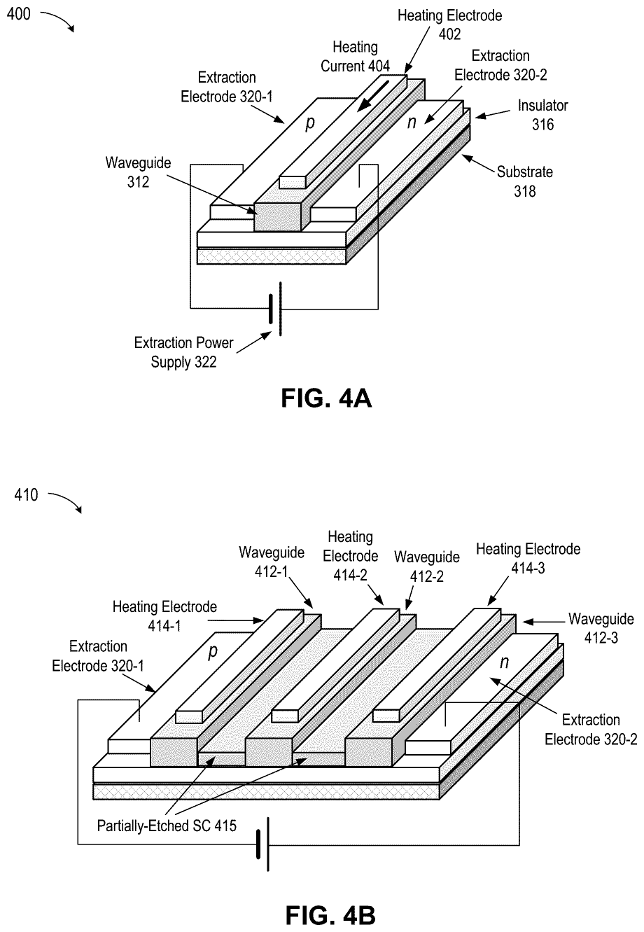

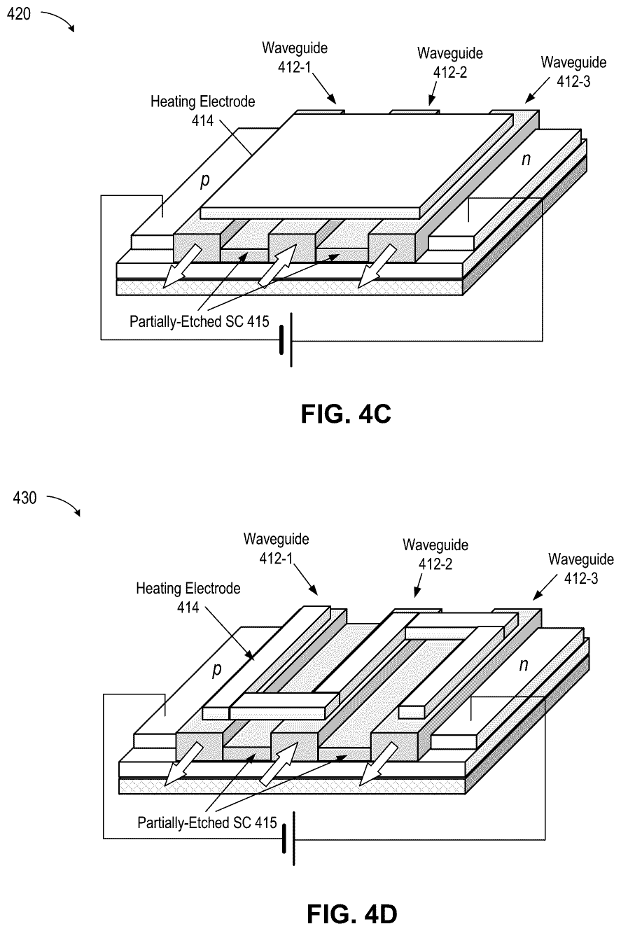

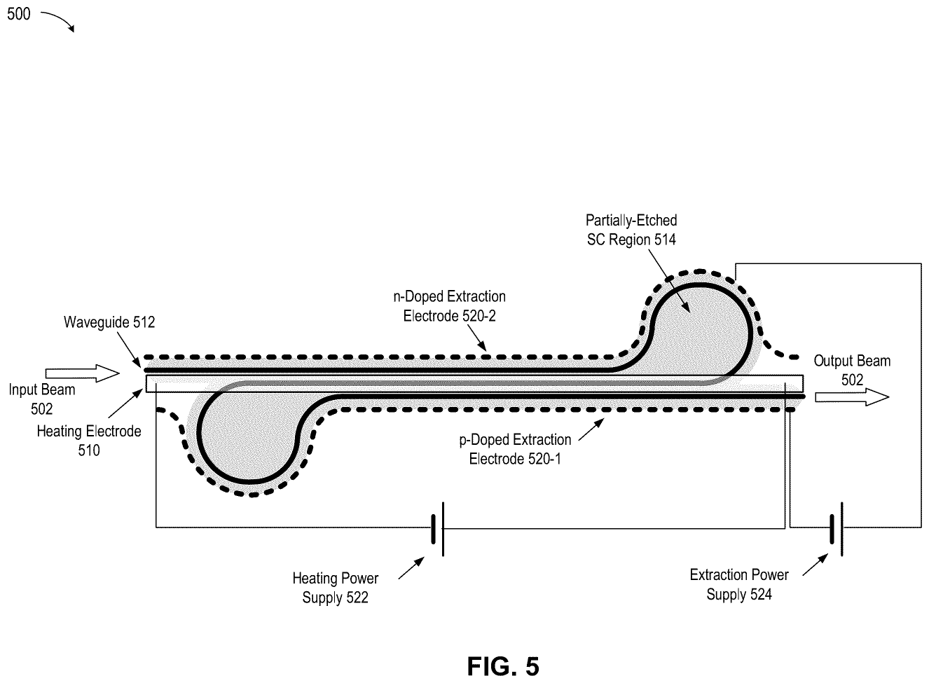

FIG. 3B illustrates one possible geometry of section 310 in which extraction electrodes 320-m are positioned at discrete locations along waveguide 312. FIGS. 4-5 illustrate other possible geometries in which extraction electrodes are located continuously for the entire length of waveguide 312 or, at least, for a substantial part of the length of waveguide 312.

FIG. 4A illustrates an example section 400 of a waveguide with both heating and extraction of photogenerated charge carriers to support controlled propagation of high-power electromagnetic waves, in accordance with some implementations of the present disclosure. Various components of FIG. 4A denoted with the same numerals that denote similar components of FIG. 3B can have the same functionality and properties. Additionally, a heating electrode 402 can be positioned in the vicinity of waveguide 312. In some implementations, heating electrode 402 can be made of a high-resistive material, e.g., Wolfram (W), Titanium Nitride (TiN), or any other suitable material with a resistivity higher than that of a material (e.g., copper, and silver) used to deliver heating current 404 to heating electrode 402. Although not explicitly shown in FIG. 4A for conciseness, an insulator layer can be deposited between waveguide 312 and heating electrode 402, to prevent carrier injection into waveguide 312, and also to prevent optical coupling between the waveguide 312 and heating electrode 402. Additionally, heating electrode 402, waveguide 312, the partially-etched region (not explicitly depicted in FIGS. 4A-D), and extraction electrodes 320-m can be covered with a cladding insulator layer (not explicitly shown in FIGS. 4A-D).

A waveguide illustrated in FIG. 4A can operate in multiple modes. In a first mode, no voltage is applied to extraction electrodes 320-m, V=0, and no heating is performed, I=0. The first mode can be used to conduct a low-power beam that requires no modulation or phase boosting, e.g., an RX beam, an LO beam, and so on. In a second mode, a nonzero voltage can be applied to extraction electrodes 320-m, V≠0, while still no heating is performed, I=0. The second mode can be used to guide a high-power beam when no modulation or phase boosting is to be imparted, e.g., while guiding a TX beam from a laser source to beam splitter 212. In a third mode, a non-zero voltage is applied to extraction electrodes 320-m, V≠0, together with heating of the waveguide, I≠0. The third mode can be used to modulate or phase-shift a high-power beam, e.g., to direct the TX beam through a switch fabric. In a fourth mode, no voltage is applied to extraction electrodes 320-m, V=0, while the waveguide is being heated, I≠0. The fourth mode can be used to direct a low-power beam (e.g., a RX beam, and a LO beam) through one or more optical switches.

FIG. 4B illustrates an example section 410 of multiple waveguides sharing a common set of extraction electrodes and equipped with separate heating electrodes, in accordance with some implementations of the present disclosure. More specifically, each of waveguides 412-1, 412-2, and 412-3 can be equipped with a respective heating electrode 414-1, 414-2, and 414-3. Common extraction electrodes 320-1 and 320-2 create a common current of photogenerated carriers across the waveguides 412-m that drains all of them concurrently. The common current flowing between extraction electrodes 320-1 and 320-2 may be supported by partially-etched semiconductors 415. In the implementation illustrated in FIG. 4B, each of the waveguides can be used for independent modulation/phase shifting of the light propagating in the respective waveguide.

FIG. 4C illustrates an example section 420 of multiple waveguides with a common heating electrode and extraction electrodes shared across multiple waveguides, in accordance with some implementations of the present disclosure. More specifically, a common heating electrode 414 can simultaneously provide heating to waveguides 412-1, 412-2, and 412-3. Because temperature in all waveguides is changed synchronously, waveguides 412-1, 412-2, and 412-3 can be the used to guide the same light in a multi-path (schematically depicted with open arrows) configuration, as further illustrated in conjunction with FIG. 5. FIG. 4D illustrates another example section 430 of multiple waveguides with a common heating electrode and extraction electrodes shared across multiple waveguides, in accordance with some implementations of the present disclosure. More specifically, a common heating electrode 414 is zigzag-shaped to provide more uniform heating to all waveguides 412-1, 412-2, and 412-3.

FIG. 5 is a top view of a waveguide structure 500 with a multi-path configuration equipped with a heating electrode and extraction electrodes, for controlled guiding of high-power electromagnetic waves in photonic integrated circuits, in accordance with some implementations of the present disclosure. An input beam 502 is incident on waveguide 512 (indicated with a thick solid line) that outputs an output beam 504, which can be modulated compared with input beam 502 via heating power supply 522 driving a current of a desired strength through heating electrode 510. The waveguide structure 500 can be manufactured, e.g., using methods of lithography, epitaxy, and/or deposition, on a single substrate (e.g., a silicon substrate). A partially-etched SC region 514 (the shaded area) can rest on an insulator layer supported by the substrate. The partially-etched region can further support waveguide 512 and a plurality of extraction electrodes 520-m, e.g., a p-doped extraction electrode 520-1 and an n-doped extraction electrode 520-2. The extraction electrodes 520-m are indicated with thick dashed lines, but it should be understood that each extraction electrode can be a single electrode extending over the whole length of waveguide 512. Extraction electrodes 520-m can be biased using a desired voltage provided by extraction power supply 524. Waveguide 512 can be folded in a multi-path configuration. For example, as shown, two portions guide light in a forward direction and one portion guides the same light in the opposite, backward, direction. In implementations, waveguide 512 can include any other number of portions (e.g., two, four, five, and seven). In some implementations, FIG. 4C or FIG. 4D can be cross-sectional views of the waveguide structure 500 of FIG. 5. As a result of the folded multi-path waveguide geometry illustrated in FIG. 5, the input beam 502 can travel a considerable distance, e.g., sufficient for the heating electrode 510 to impart a significant phase change, while keeping the total length of the waveguide structure 500 small. The waveguide structure 500 can be used as a basis for phase shifters, phase modulators, optical switches, and any other PIC elements that use thermo-optic effect to change phase of light. Although, for brevity and conciseness, heating power supply 522 is shown as a DC power supply, in some implementations, heating power supply 522 can be an ac power supply that can be controlled by voltage/current controller 226.

PICs deployed in various implementations disclosed in conjunction with FIGS. 1-5 (or other similar systems and components) can be implemented on a single chip (substrate), e.g., Silicon chip, Silicon Oxide chip, Indium Phosphate chip, Silicon Nitride chips, diamond-based chips, and the like, and can integrate multiple optical elements and functions. PICs can be manufactured using multiple materials, e.g., III-V compound semiconductors (GaAs, InSb, etc.) integrated with Silicon or Germanium. The chip can be manufactured using any suitable methods of lithography, epitaxy, physical vapor deposition, chemical vapor deposition, plasma-assisted deposition, or any other suitable techniques of wafer-scale technology. PICs can operate in the visible light domain (300-700 nm wavelength) or in the infrared domain (above 1000 nm). PICs can include components designed and manufactured to generate light, guide light, manipulate light by changing amplitude, frequency, phase, polarization, spatial and temporal extent of light, transform energy of light into other forms, such as energy of electric current, energy of mechanical vibrations, heat and the like.

PICs can include any number of integrated light sources, such as light-emitting diodes (LEDs), semiconductor lasers diodes, quantum dot lasers (e.g., quantum dot lasers monolithically grown on Silicon), Germanium-on-Silicon lasers, Erbium-based lasers, Raman lasers, integrated III-V compound semiconductors on Si substrate, and the like. In some implementations, PICs can operate on light generated by lasers and other light sources located off-chip and delivered to PICs via any number of optical switches and optical fibers.

PICs can include any number of waveguides, which can serve as elemental building blocks of a PIC's light transportation system, connecting various elements and components. Waveguides can include metallic waveguides, dielectric waveguides, doped semiconductor waveguides, and the like. Waveguides can be single-mode waveguides or multi-mode waveguides. Waveguides can be passive waveguides or active waveguides with gain medium, which can increase the amplitude of the light guided therethrough. Dielectric waveguides can be engineered with high refractive index layers surrounded by lower refractive index materials, which can be deposited and shaped to a designed form using deposition and etching manufacturing techniques.

PICs can include any number of beam splitters, e.g., power splitters, beam combiners, directional couplers, grating couplers, and the like. PICs can include optical circulators, e.g., Faraday effect-based circulators, birefringent crystal-based circulators, and so on. PICs can include any number of optical amplifiers, such as Erbium-doped amplifiers, waveguide-integrated amplifiers, saturation amplifiers, and the like. PICs can further include any number of phase shifters, such as optomechanical phase shifters, electro-optical phase shifters, e.g., shifters operating by exercising electrical or mechanical control of the refractive index of an optical medium, and the like.

PICs can include any number of optical modulators, including indium phosphide modulators, Lithium Niobate modulators, Silicon-based modulators, acousto-optic modulators, electro-optic modulators, electro-absorption modulators, Mach-Zehnder modulators, and the like. In some implementations, optical modulators can use carrier injection, radiation amplification, and other techniques. Optical modulators can include various optomechanical components, e.g., components that modulate the refractive index of a waveguide due to the displacement of a mechanically moveable part placed next to the waveguide, which in turn induces a phase shift (or a directional shift) to the propagating light field.

PICs can include any number of single-photon detectors, e.g., superconducting nanowire single-photon detectors (SNSPDs) or superconducting film single-photon detectors, which can be integrated with diamond or silicon substrates. PICs can include any number of interferometers, such as Mach-Zehnder interferometers.

PICs can include any number of multiplexers/demultiplexers, including wavelength division multiplexers/demultiplexers, phased-array wavelength multiplexers/demultiplexers, wavelength converters, time division multiplexers/demultiplexers, and the like.

PICs can further include any number of photodetectors, including silicon photomultipliers, photodiodes, which can be Silicon-based photodiodes, Germanium-based photodiodes, Germanium-on-Silicon-based photodiodes, III-V semiconductor-based (e.g., GaAs-based) photodiodes, avalanche photodiodes, silicon photomultipliers (SiPMs), and so on. Photodiodes can be integrated into balanced photodetector modules, which can further include various optical hybrids, e.g., 90-degree hybrids, 180-degree hybrids, and the like.

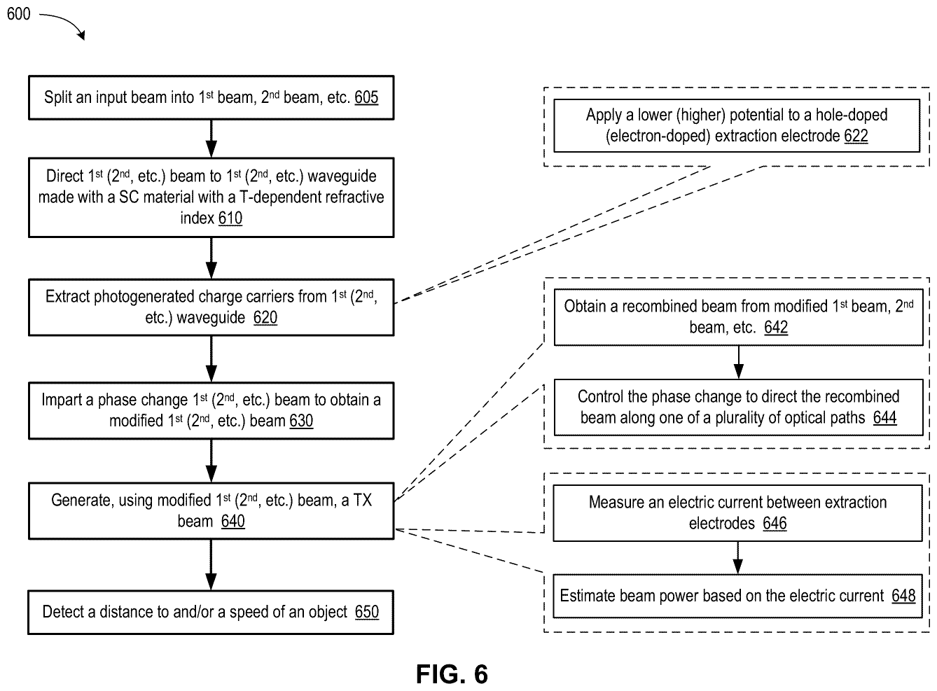

FIG. 6 depicts a flow diagram of an example method 600 of operating an optical sensing system (e.g., a lidar) that uses high-power sensing beams enabled by extraction of photogenerated carriers, in accordance with some implementations of the present disclosure. Method 600 can be performed using systems and components described in relation to FIGS. 1-5, e.g., optical sensing system of FIG. 2A or FIG. 2B. Method 600 can be performed as part of obtaining range and velocity data that characterizes any suitable environment, e.g., an outside environment of a moving vehicle, including but not limited to an autonomous vehicle. Various operations of method 600 can be performed in a different order compared with the order shown in FIG. 6. Some operations of method 600 can be performed concurrently with other operations. Some operations of method 600 can be optional. Method 600 can be used to improve the range, efficiency, and reliability of velocity and distance detections by lidar devices. Any of the optical elements and components used to perform method 600, e.g., waveguides, optical switches, modulators, phase shifters, extraction electrodes, heating electrode, and the like, can be integrated on a photonic integrated circuit.

At an optional (as indicated by the dashed box) block 605, method 600 can include splitting an input beam into a plurality of beams, e.g., a first beam, a second beam, a third beam, and so on. The input beam can be a TX beam 205 in FIG. 2A or FIG. 2B, or any other high-power beam. The input beam can be a beam input into an optical switch or a switch fabric having multiple optical switches. An optical switch can be configured to selectively direct an input beam to one of a plurality of optical paths and can include a first waveguide and a second waveguide. At block 610, method 600 can include directing a first beam to the first waveguide and directing the second beam to the second waveguide. For example, an optical switch can include a beam splitter configured to direct a first portion of the input beam (“first beam”) to the first waveguide and direct a second portion of the input beam (“second beam”) to the second waveguide. The first waveguide and the second waveguide can include a semiconducting material with a temperature-dependent refractive index (e.g., silicon). In those implementations, where the input beam is not split (e.g., a phase shifter, and an optical modulator) into multiple beams, the input beam and the first beam can be the same beam. In multi-path waveguides, the first waveguide and the second waveguide can be portions of a common waveguide (as illustrated in FIG. 5), so that the second beam in the second waveguide can be the first beam propagating in a reverse direction.

At block 620, method 600 can continue with extracting, using a plurality of extraction electrodes, from the first waveguide, charge carriers generated by the first beam in the first waveguide. The extraction of (photogenerated) charge carriers, e.g., electrons and holes, can be responsive to a voltage configuration that facilitates removal of photogenerated holes into an p-doped extraction electrode and removal of photogenerated electrons into an n-doped extraction electrode, e.g., as illustrated in FIG. 3B. More specifically, as indicated with block 622 in the top callout portion in FIG. 6, the voltage configuration for efficient removal of photogenerated carriers can include a lower potential applied to a first extraction electrode of the plurality of extraction electrodes, wherein the first extraction electrode comprises the semiconductor material that is hole-doped (p-doped). The voltage configuration can further include a higher potential applied to a second extraction electrode of the plurality of extraction electrodes, wherein the second extraction electrode comprises the semiconductor material that is electron-doped (n-doped). In some implementations, the same plurality of extraction electrodes can be used to extract, responsive to the same voltage configuration, charge carriers from multiple waveguides (e.g., as illustrated in FIGS. 4B-D), e.g, from both the first waveguide and the second waveguide.

At block 630, method 600 can include using a heating electrode to impart a phase change to a first beam to obtain a modified first beam. The heading electrode can conduct electric current and cause a change in temperature of a waveguide by transferring Joule heat to the waveguide. The change in temperature can modify a refractive index of the waveguide material and impart a change to the beam propagating through the waveguide. In the implementations where an input beam is split into multiple beams (e.g., interferometers, and optical switches), or where different waveguides carry separate (e.g., unrelated) beams, the phase change of each beam can be changed separately. For example, a first heating electrode can be configured to cause a change of temperature of the first waveguide while a second heating electrode is configured to cause a change of temperature of the second waveguide. In some implementations, the first heating electrode can be configured to cause a change of a temperature of both the first waveguide and the second waveguide (e.g., as illustrated in FIGS. 4C-D).

In some implementations, an electronic circuit (e.g., voltage/current controller 226 in FIG. 2A or FIG. 2B) can be configured to provide a modulation signal to the first (second, etc.) heating electrode that induces a modulation (or any other phase change) in the respective beam. The modulation signal can be a dc signal (e.g., when a fixed phase change is being imparted to the respective beam) or an AC signal (e.g., when the imparted phase change is time-dependent).

At block 640, method 600 can continue with generating, using the modified first beam, a transmitted (TX) beam. Generating the TX beam can include any number of intervening operations with the modified beam. For example, as indicated with the lower callout portion of FIG. 6, such operations (e.g., performed by an optical switch) can involve obtaining, at block 642, a recombined beam that combines the modified first beam with the second (third, etc.) beam. In some implementations, the phase of one of the combined beams (e.g., the first beam) can be changed whereas the phase of the other beam(s) can be unchanged. As indicated by block 644, controlling the phase change can be used to direct the recombined beam along one of a plurality of optical paths. More specifically, the heating electrodes can have multiple heating configurations (e.g., selectable by voltage/current controller 226 in FIG. 2A or FIG. 2B). In a first heating configuration, the heating electrodes can cause the input beam to follow a first optical path of the plurality of optical paths. In a second heating configuration, the heating electrodes can cause the input beam to follow a second optical path of the plurality of optical paths.

In some implementations, at block 646, method 600 can include measuring (e.g., using current detector 324 of FIG. 3B) an electric current flowing between the first extraction electrode and the second extraction electrode. At block 648, method 600 can include estimating a power of the beam propagating in one or more waveguides based on the measured electric current.

At block 650, method 600 can include using the TX to detect at least one of (i) a distance to an object in an outside environment or (ii) a speed of the object. Using the TX beam can include any number of additional operations, e.g., amplifying the TX beam, directing the TX beam to one or more interface couplers, focusing the TX beam, collimating the TX beam, collecting a received (RX) beam reflected from the object, processing the RX beam, and/or performing any other operations, e.g., including but not limited to any operations described in conjunction with FIG. 2A. Any of the optical components referenced in conjunction with method 600 can be implemented on a photonic integrated circuit (PIC).

Some portions of the detailed description above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems can be used with programs in accordance with the teachings herein, or it can prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. An optical device comprising:
a first waveguide comprising a semiconducting material with a temperature-dependent refractive index;
a plurality of extraction electrodes configured to extract, responsive to a voltage configuration, from the first waveguide, charge carriers generated by a first electromagnetic wave propagating in the first waveguide; and
a first heating electrode configured to cause a change of a temperature of the first waveguide.

2. The optical device of claim 1, further comprising:
a second waveguide comprising the semiconducting material, wherein the plurality of extraction electrodes are further configured to extract, responsive to the voltage configuration, from the second waveguide, charge carriers generated by a second electromagnetic wave propagating in the second waveguide; and
a second heating electrode configured to cause a change of a temperature of the second waveguide.

3. The optical device of claim 2, further comprising:
an optical switch configured to selectively direct an input beam to one of a plurality of optical paths, the optical switch comprising:
the first waveguide and the second waveguide,
a beam splitter configured to (i) direct a first portion of the input beam to the first waveguide, and (ii) direct a second portion of the input beam to the second waveguide; and
a plurality of heating electrodes comprising the first heating electrode and the second heating electrode, wherein,
in a first heating configuration, the plurality of heating electrodes cause the optical device to direct the input beam to a first optical path of the plurality of optical paths, and
in a second heating configuration, the plurality of heating electrodes cause the optical device to direct the input beam to a second optical path of the plurality of optical paths.

4. The optical device of claim 1, further comprising:
a second waveguide comprising the semiconducting material, wherein the plurality of extraction electrodes are further configured to extract, responsive to the voltage configuration, from the second waveguide, charge carriers generated by a second electromagnetic wave propagating in the second waveguide; and
wherein the first heating electrode is further configured to cause a change of a temperature of the second waveguide.

5. The optical device of claim 4, wherein the first waveguide and the second waveguide are portions of a common waveguide, and wherein the second electromagnetic wave comprises the first electromagnetic wave propagating in a reverse direction.

6. The optical device of claim 1, further comprising:
an electronic circuit configured to provide a modulation signal to the first heating electrode, wherein the modulation signal causes a modulation of the first electromagnetic wave.

7. The optical device of claim 1, further comprising an electronic circuit configured to:
measure an electric current flowing between a first extraction electrode of the plurality of extraction electrodes and a second extraction electrode of the plurality of extraction electrodes; and
estimate a power of the first electromagnetic wave based on the measured electric current.

8. The optical device of claim 1, wherein the semiconducting material comprises silicon.

9. The optical device of claim 1, wherein a first extraction electrode of the plurality of extraction electrodes comprises the semiconductor material that is hole-doped, and wherein a second extraction electrode of the plurality of extraction electrodes comprises the semiconductor material that is electron-doped.

10. The optical device of claim 9, wherein the voltage configuration comprises application of a higher potential applied to the first extraction electrode and a lower potential applied to the second extraction electrode.

11. A lidar system comprising:
a light source configured to generate a transmitted (TX) beam; and
a photonic integrated circuit (PIC) comprising:
a waveguide configured to guide the TX beam, wherein the waveguide comprises a semiconducting material; and
a plurality of extraction electrodes configured to extract, responsive to a voltage configuration, from the semiconducting material of the waveguide, charge carriers generated by the TX beam.

12. The lidar system of claim 11, wherein the PIC further comprises:
a heating electrode configured to cause a change of a temperature of the waveguide.

13. The lidar system of claim 12, wherein the PIC further comprises:
an electronic circuit configured to communicate a modulation signal to the heating electrode, wherein the modulation signal causes a modulation of the TX beam.

14. The lidar system of claim 12, wherein a first extraction electrode of the plurality of extraction electrodes comprises the semiconductor material that is electron-doped,
wherein a second extraction electrode of the plurality of extraction electrodes comprises the semiconductor material that is hole-doped, and
wherein the voltage configuration comprises applying a lower potential to the first extraction electrode and a higher potential to the second extraction electrode.

15. The lidar system of claim 11, wherein the PIC further comprises:
one or more optical switches configured to selectively guide the TX beam to one or more of a plurality of optical interfaces configured to output the TX beam to an outside environment, wherein each optical switch of the one or more optical switches comprises:
a first waveguide and a second waveguide, wherein the first waveguide and the second waveguide comprise the semiconducting material with a temperature-dependent refractive index;
a beam splitter configured to (i) direct a first portion of the TX beam to the first waveguide and (ii) direct a second portion of the TX beam to the second waveguide;
a plurality of heating electrodes configured to:
in a first heating configuration, cause the TX beam to follow a first optical path, and
in a second heating configuration, cause the TX beam to follow a second optical path; and
a plurality of extraction electrodes configured to extract, responsive to a voltage configuration, from each of the first waveguide and the second waveguide, charge carriers generated by a respective portion of the TX beam.

16. A method to operate a lidar device, comprising:
directing a first beam to a first waveguide comprising a semiconducting material with a temperature-dependent refractive index;
using a plurality of extraction electrodes to extract, from the first waveguide, charge carriers generated by the first beam in the first waveguide;
using a heating electrode to impart a phase change to the first beam to obtain a modified first beam;
generating, using the modified first beam, a transmitted beam; and
using the transmitted beam to detect at least one of (i) a distance to an object in an outside environment or (ii) a speed of the object.

17. The method of claim 16, further comprising:
measuring an electric current flowing between a first extraction electrode of the plurality of extraction electrodes and a second extraction electrode of the plurality of extraction electrodes; and
estimating a power of the first beam based on the measured electric current.

18. The method of claim 16, wherein using the plurality of extraction electrodes comprises:
applying a lower potential to a first extraction electrode of the plurality of extraction electrodes, wherein the first extraction electrode comprises the semiconductor material that is hole-doped; and
applying a higher potential to a second extraction electrode of the plurality of extraction electrodes, wherein the second extraction electrode comprises the semiconductor material that is electron-doped.

19. The method of claim 16, wherein the first waveguide, the plurality of extraction electrodes and the heating electrode are integrated in a photonic integrated circuit.

20. The method of claim 16, further comprising:
splitting an input beam into the first beam and at least a second beam;
directing the second beam to a second waveguide, wherein the second waveguide comprises the semiconducting material;
obtaining a recombined beam comprising the modified first beam and at least the second beam; and
controlling the phase change to direct the recombined beam along one of a plurality of optical paths.
